(19) United States
(12) Patent Application Publication
(10) Pub. No.: US 2008/0000368 A1
(43) Pub. Date: Jan. 3, 2008

(54) Punching, Embossing, Engraving or Printing System

(75) Inventor: Angelo Bartesaghi, Lecco (IT)

Correspondence Address: HEDMAN & COSTIGAN P.C., 1185 AVENUE OF THE AMERICAS, NEW YORK, NY, 10036, US

(73) Assignee: OMET S.R.L., LECCO (IT)

(21) Appl. No.: 11/794,385

(22) PCT Filed: Feb. 28, 2006
(86) PCT No.: PCT/EP06/01889

§ 371 Date: Jun. 27, 2007

(30) Foreign Application Priority Data
Mar. 3, 2005 (IT) MI2005A000331

(51) Int. Cl. B41F 5/00; B44B 5/00

(52) U.S. Cl. 101/216

(57) ABSTRACT

A punching, embossing, engraving or printing system wherein a continuous strip of material (17), which extends along a certain run, interacts with a rotating element equipped with a punching, embossing, engraving or printing ring (12, 112, 212), having one or more metal punching sheets or cliches (15, 115; 16, 116), and a pair of contrast cylinders (13, 113; 14, 114) collaborating therewith (12, 112, 212), envisaging a phasing group (18, 118), which can be raised or lowered, wherein the continuous strip (17) always advances at a constant rate and the rotating element equipped with a punching, embossing, engraving or printing ring (12, 112, 212), rotates at a constant rate in the punching, embossing, engraving or printing phase, whereas it rotates at a varying rate in relation to the dimension of the one or more metal punching sheets or cliches in the absence of the operative punching, embossing, engraving or printing phase. The rotating element equipped with a punching, embossing, engraving or printing ring (12, 112, 212) can be a cylinder or belt and the operating procedure is repeated for the desired length of the strip (17) to be printed.

The present invention relates to a punching, embossing, engraving or printing system with a limited encumbrance.

There are numerous applications in the field of punching, embossing, engraving and printing systems, which, however, have limitations with respect to both the type of production and quantity being produced.

A first type of known punching machine, for example, can comprise a pair of opposite cylinders on which cutting shapes are arranged to generate the punching of a sheet of material which is fed between the cylinders. In this application, the development of the punched product is identified by the outer diameter (each punched item has a length equal to the circumference of the cylinder).

Every time a change in product is required (development and/or shape of the punched product), the cylinders must be substituted with consequent long stoppage times. Moreover, there will be considerable lock up costs of the pairs of cylinders.

In a second type which attempts to solve the above problems, the punching machines comprise a pair of cylinders, so-called magnetic cylinders, on which specific metal sheets are arranged by magnetic retention. These metal sheets partially occupy the development of the side surface of each magnetic cylinder. In this respect, it should be pointed out that the length of the punched product is determined by the development of the portion of side surface of the magnetic cylinder alone and that, in order to change the development and/or shape of the punched product, it is sufficient to only substitute the metal sheet with another metal sheet having a different development and shape.

There is consequently a saving in the construction of the cylinders but there are considerable problems relating to the production versatility. If the strip of material, in fact, is fed between the magnetic cylinders at a constant rate, a punched product is obtained at the outlet, having a length equal to the development of the metal sheet followed by a non-punched portion of material having a length equal to the difference between the development of the side surface of the magnetic cylinder and the development of the metal sheet.

This punching system therefore results in an excessive waste of material, above all in the case of metal sheets having a small development.

In order to try and solve this latter problem, the feeding rate of the strip of material towards the pair of punching cylinders is varied. In short, the strip is advanced at the same rate as the magnetic cylinders when it passes between the metal sheets, it is then brusquely decelerated and its advance direction is inverted so that it moves backwards when it passes between the areas of the magnetic cylinders without metal sheets and is finally accelerated again to reach the metal sheets at a constant rate for the beginning of a new punching cycle. Even if this procedure allows the portion of non-punched strip to be reduced to the minimum, the system has drawbacks deriving from the considerable stress to which the strip of material is subjected (brusque accelerations and decelerations), and also the difficulty in synchronizing the accelerations and decelerations of the strip with the metal sheet format and rotation rate of the magnetic rolls.

There are further problems in the field of printing machines which are generally linked to the dimension of the cylinders and the dimension and form of the part to be printed.

A general objective of the present invention is therefore to solve the disadvantages of the known art specified above, by providing a punching, embossing, engraving or printing system with a limited encumbrance and wide versatility which allows the construction costs of the cylinders and stoppage times for adapting the machine to the product to be punched, embossed, engraved or printed, to be reduced to the minimum.

An objective of the present invention is to provide a punching/embossing/engraving/printing machine and punching/embossing/engraving/printing methods which have a limited encumbrance, with a minimum number of constituents.

A further objective of the present invention is to reduce all stress on the strip of material to be punched, embossed, engraved or printed, to the minimum, also reducing to the minimum all waste of material during the punching/embossing/engraving/printing.

An additional objective of the present invention is to provide a punching/embossing/engraving/printing machine and punching/embossing/engraving/printing methods which are economical and easy to produce.

These objectives according to the present invention are achieved by providing a punching, embossing, engraving machine, a punching, embossing, engraving method and a printing machine and printing method whose characteristics are specified in the enclosed independent claims.

Further important, particular and advantageous characteristics of the present invention are object of the dependent claims.

The characteristics and advantages of a punching, embossing, engraving or printing system with a limited encumbrance according to the invention will appear more evident from the enclosed description, provided for illustrative and non-limiting purposes, of an embodiment with reference to the enclosed figures in which:

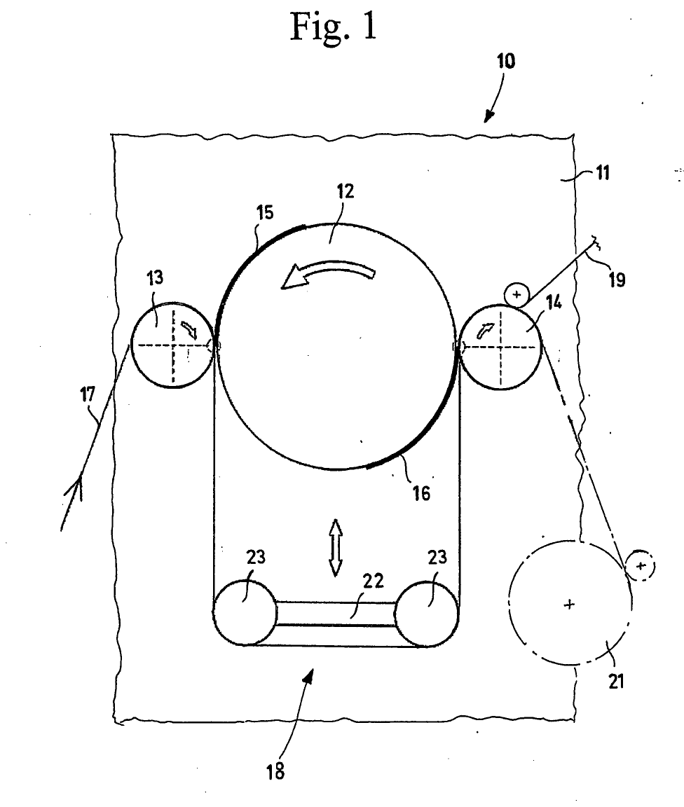

FIG. 1 is a schematic raised side view of a punching machine according to the present invention in a first phase;

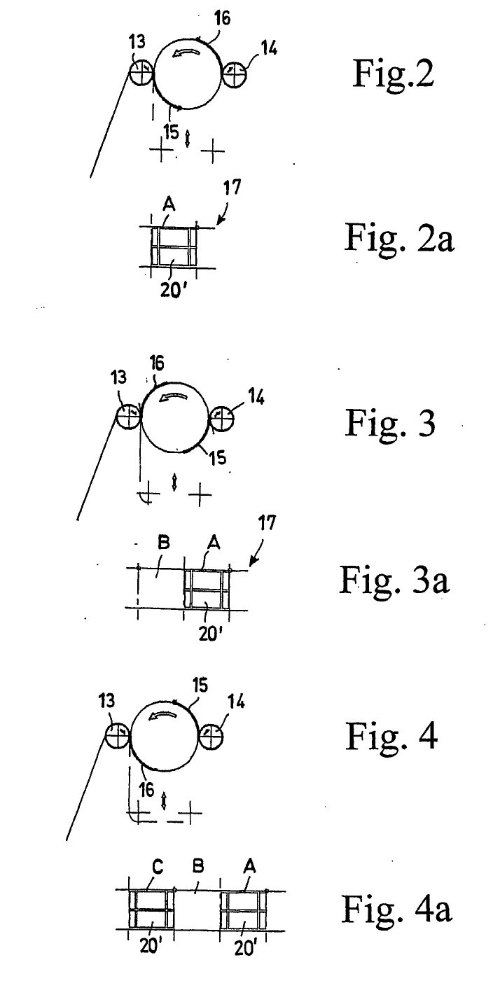

FIG. 2 is a similar view to that of FIG. 1, in a second punching operation phase in which a first punching step of a strip of material fed has been effected and FIG. 2A is a schematic plan view which illustrates the punching obtained on the strip of material in the phase shown in FIG. 2;

FIGS. 3-3a to 7-7a are views of further operative punching phases carried out by the first contrast cylinder and the punching cylinder;

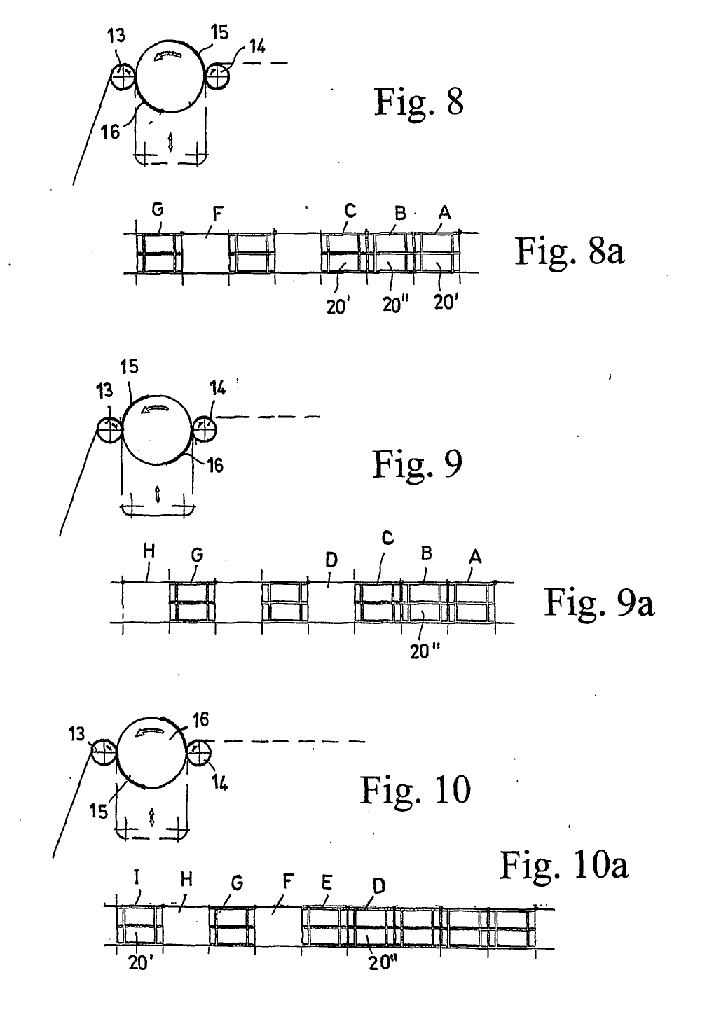

FIGS. 8-8a to 10-10a are views of further operative punching phases carried out by both the first contrast cylinder and the second contrast cylinder with the punching cylinder;

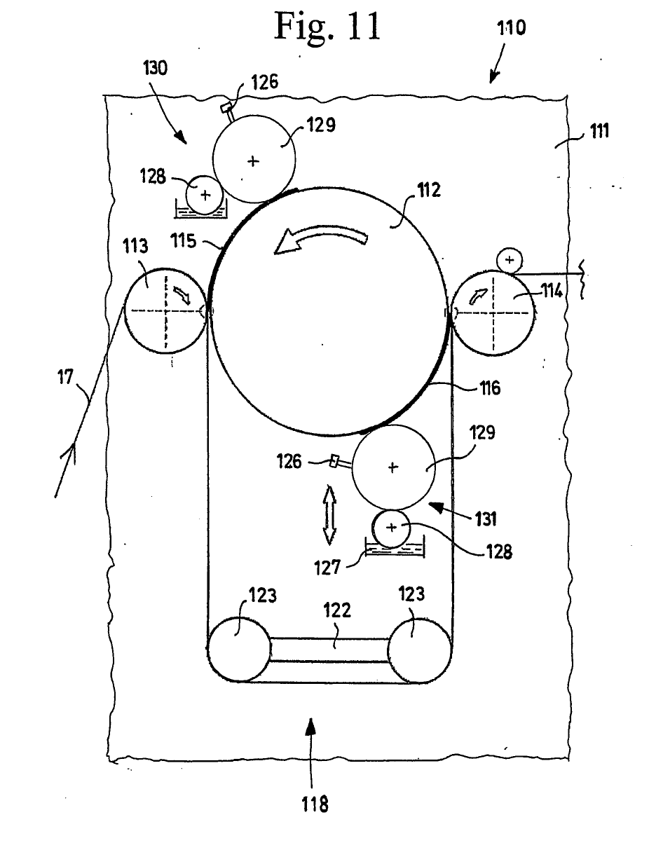

FIG. 11 is a schematic raised side view of a printing machine according to the present invention illustrated in a first printing start phase of a continuous strip of material;

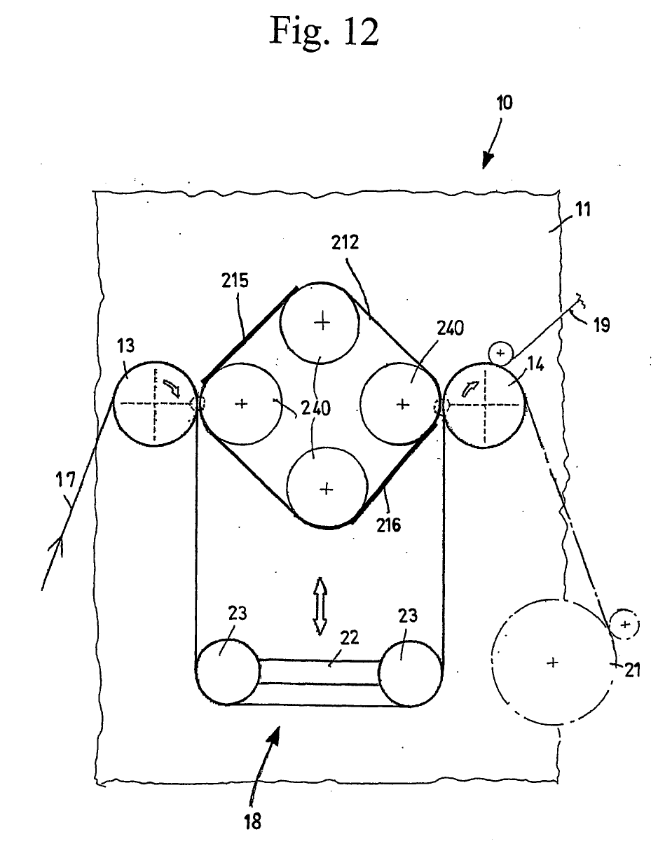

FIG. 12 is a schematic raised side view of a further punching machine according to the present invention in a first phase according to that of FIG. 1;

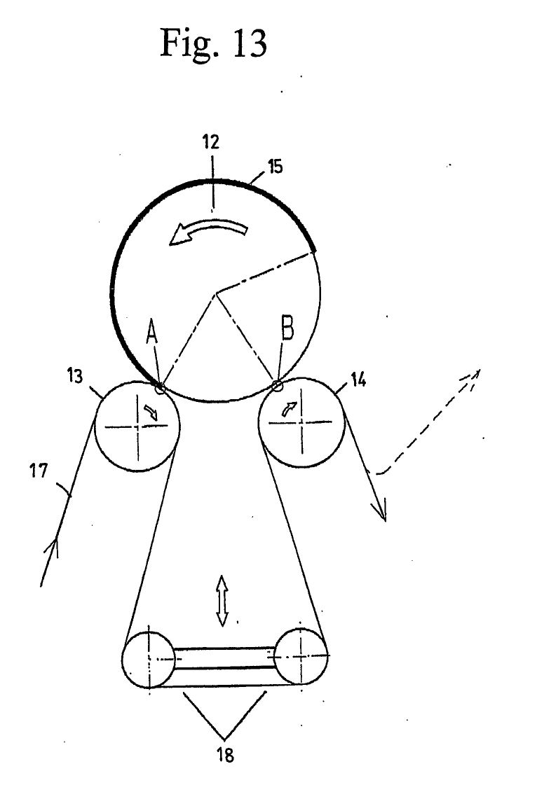

FIG. 13 shows a further embodiment according to the invention.

With general reference to the various FIGS. 1-10, these schematically show a punching machine according to the invention, indicated as a whole with 10 and illustrated in its first embodiment which envisages a punching turret, schematized in 11, the use of a punching cylinder 12 in collaboration with a pair of contrast cylinders 13 and 14.

The punching cylinder 12 can be of the magnetic type so as to withhold, on its side surface, two metal sheets 15 and 16 having the circle-arc configuration of a curved plate according the above-mentioned cylinder side, with a curvature radius substantially equal to the curvature radius of the punching cylinder. The metal sheets 15 and 16 have such a conformation as to generate the punching of a sheet of material, according to a pre-established shape, for example a series of labels.

In any case, an alternative method known to experts in the field, can consist of non-magnetic punching cylinders with metal sheets having another type of fixing, for example any kind of mechanical fixing means.

Upstream of this punching turret 11, the strip of material 17 is fed, for example unwound from a reel (not shown). The strip of material 17 passes first between the contrast cylinder 13 and the punching cylinder 12, is then sent towards a phasing group 18, and subsequently passes between the second contrast cylinder 14 and the punching cylinder 12, before a cobweb of off-cuts of material 19 is rewound. In the case of the production of labels (not shown) the end-product is rewound to form a reel 21 ready for a subsequent use.

As can be seen in the example, the phasing group 18 can comprise a so-called “dancer” arrangement consisting of a rod 22, carrying a pair of return rolls 23 at its ends, on which the strip of material 17 runs. The phasing group 18 can be raised or lowered, before the activation of the punching operation, so as to establish the quantity of material diverted between a punching effected in correspondence with the first contrast cylinder 13 and the subsequent punching effected in correspondence with the second contrast cylinder 14. This quantity is essentially determined in relation to the diameter of the punching cylinder, as multiples (three, five, etc.) of the length of the format or punching section and the respective subsequent section, the rate of both the punching and contrast cylinders.

A succession of operative phases is shown below, in the various FIGS. from 1 to 10a, which illustrate the punching method according to the present invention in a machine such as that described above.

The strip of material 17 advances in the punching machine 10 at a constant rate and is punched by the metal sheets 15 and 16 situated on the punching cylinder 12 in collaboration with the relative contrast cylinders 13 and 14. Before activating this punching procedure, the punching must be set or phased in relation to the length of the metal sheets selected. These metal sheets can in fact have a development on the side surface of the punching cylinder according to an angle ranging from 0° to 180° which can be greater, the same as or less than 90°. It is consequently evident that, according to the invention, the possible variations in the dimensions of the punched product are in relation to the diameter of the punching cylinder and necessary presence on its surface of at least two punchers in the form of metal sheets 15, 16 or the like.

FIG. 1 shows a first phase in which the strip of material 17 is fed between the first contrast cylinder 13 and the punching cylinder 12, of which the first metal sheet 15 is not yet in an engagement position with respect to the contrast cylinder 13.

FIG. 2, on the other hand, shows a subsequent phase in which the strip of material 17 is passed between the first contrast cylinder 13 and the punching cylinder 12 in correspondence with the presence of the first metal sheet 15. A first punched product 20′ has thus been generated in a section A of the strip 17 (FIG. 2a). It can be seen how in front of the punched product 20′, there is a section of non-punched strip of material as it has passed between the cylinders 13 and 12 in the area in which there are no metal sheets. Subsequently, with the advancing of the strip 17, this initial non-punched section will also pass between the punching cylinder 12 and the second contrast cylinder 14, in the presence of one of the metal sheets 15 or 16, and will be punched, completing the punching of the whole strip of material 17. From this point, as in traditional procedures, there can be an immediate production, for example in a rewound reel, of finished punched products in the form of labels.

The strip of material 17, however, advances, passing through the phasing group 18 and the punching cylinder 12 rotates bringing the area of its side surface without metal sheets into contact with the first contrast cylinder 13. In this way, the position of FIG. 3 is obtained, with the metal sheet 16 which is ready to operate and the plan arrangement of the strip 17 shown in FIG. 3a, in which a section A which envisages a first punched product 20′ is followed by an empty section B having the dimension of a format.

It should also be considered that the initial part of the strip 17 is presumably still in the area of the phasing group 18 as it was initially decided to operate with a section of material between the two contrast cylinders 13, 14 and the phasing group 18 equal to three formats created by the punching cylinder 12 in collaboration with the first contrast cylinder 13 with relative alternating empty sections. In this way, a metal sheet of the punching cylinder 12 will intervene on the strip of material 17 in collaboration with the second contrast cylinder 14 after the passage of a length equal to six formats or sections between the punching cylinder 12 and the first contrast cylinder 13.

FIGS. 4 and 4a show a repetition of what has been described in relation to section A for FIGS. 2 and 2a with the consequent formation by the intervention of the metal sheet 16 of a second punched product 20′ in a section C following section B previously left empty.

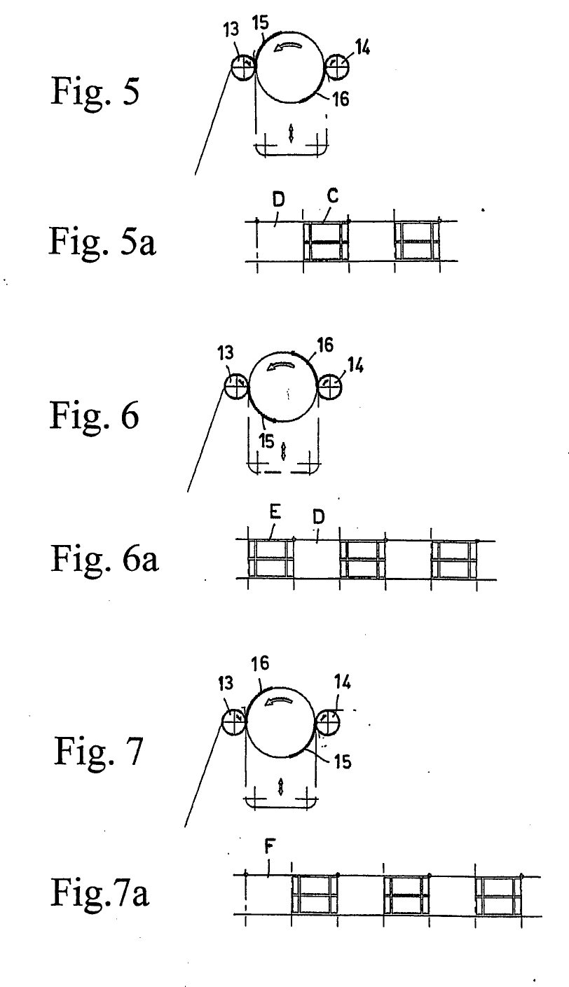

The same considerations made for FIGS. 3 and 3a are repeated for FIGS. 5 and 5a, which represent a duplication of what is illustrated and described for a new empty section D of the strip of material 17.

In the subsequent phase shown in FIGS. 6, 6a and 7, 7a, the punching operation is terminated, in which the punching is effected with the strip of material passing between the punching cylinder 12 and the first contrast cylinder 13 alone. A third punched product 20′ is therefore created in a new section E in addition to a last empty section F having the dimension of a format.

At this point, according to the invention, the second contrast cylinder 14 which collaborates with the punching cylinder 12 i.e. with the metal sheets 15 and 16 present on its side surface, begins operating on the strip of material 17.

FIGS. 8 and 8a show how the contemporaneous double punching is effected on the one hand between the punching cylinder 12 and the first contrast cylinder 13 and on the other between the punching cylinder 12 and the second contrast cylinder 14 with the production of a punched product 20′ in a new section G and a punched product 20″ in section B previously left empty.

FIGS. 9 and 9a show the position reached after the subsequent phase in which areas of the punching cylinder 12, without metal sheets 15 and 16, are passed facing the respective contrast cylinders 13 and 14. A new empty section H is therefore generated on the one hand and on the other, the punched product 20′ of section C simply passes between the cylinders 14 and 12.

The continuous punching operation then proceeds with the repetition of the phases described above, as shown for example in FIGS. 10 and 10a, with the creation of a whole series of punched products 20′, 20″ from the strip of material 17.

According to the invention, it should be pointed out that the strip of material 17 always advances at the same rate, once this has been established. Furthermore, the cylinders 12, 13 and 14 rotate at a peripheral rate which is the same as the rate of the material when there is the presence of metal punching sheets 15 and 16 in contact with the strip of material and with the respective contrast cylinders 13 and 14. When the cylindrical surface areas of the punching cylinder 12, without said metals sheets, are facing the strip of material 17, on the other hand, the cylinder 12 rotates at the same rate as the strip when these areas occupy a development on the side surface having an angle of 90°. When the metal sheet 15 or 16 occupies a development on the side surface which is less than 90°, the cylinder 12 rotates at a peripheral rate which is greater than the strip (with consequent acceleration and deceleration) and finally, when the metal sheet 15 or 16 occupies a development on the side surface which is greater than 90°, the cylinder 12 rotates at a peripheral rate which is lower than the strip (with consequent deceleration and acceleration). In this way, there is an adaptation of the position of the metal sheets with respect to the sections of material to be punched in relation to the shape and length of the format to be obtained.

FIG. 12 shows an alternative arrangement to that illustrated in FIG. 1 which envisages a punching belt 212 having a pair of metal sheets 215 and 216 in the place of the punching cylinder 12. The punching belt 212 is arranged for this purpose according to a closed ring circuit, supported around internal guiding and contrast rolls 240.

Also in this case, according to the invention, there is therefore the presence of a rotating ring element 12, 212 which carries the pair of metal sheets 15, 16, 215, 216 to operate with the contrast cylinders 13 and 14 to effect the punching according to the phases described above in the presence of the punching cylinder 12.

In an alternative embodiment, on the cylinder 12 or belt 212, there can be only one metal sheet 15 which collaborates with the contrast cylinders 13, 14. In this case therefore, the rotating punching, embossing, engraving or printing ring element in the form of a cylinder or belt, carrying a punching, embossing, engraving metal sheet or cliché and a pair of contrast cylinders 13, 14 collaborating therewith, gives non-diametrally-opposite parts envisaging a phasing group which can be raised or lowered 18.

In this case, the strip of material 17 always advances at a constant rate and when the cylinder 12 carries the metal sheet 15 in contact with the rolls 13 and 14, it also rotates at a constant rate. When the tail of the metal sheet 15 is disengaged from the roll 14, the cylinder 12 accelerates or decelerates in relation to the lesser or greater length of the metal sheet 15 with respect to half of the circumference. The same thing occurs in the presence of a belt carrying a metal sheet instead of the cylinder.

It should be taken into account, however, that, according to the invention, a machine and method as described can also be advantageously used for the printing of a continuous strip of material, selectively and alternatively using a cliché-holder or printing cylinder or a cliché-holder or printing belt.

FIG. 11, in fact, illustrates the possible arrangement of the invention in a flexographic printing machine 100. Said printing machine 100 comprises a printing turret 111 in which a strip of material 17 to be printed advances.

The printing turret 111 comprises a cliché-holder cylinder 112 and two printing contrast cylinders 113 and 114 associated therewith. A pair of clichés 115 and 116 which define the format to be printed, are assembled on the cliché-holder cylinder 112.

It should also be noted that a pair of inking groups 130 and 131 are situated tangent to the cliché-holder cylinder 112, on opposite sides. Each inking group 130 or 131 comprises an anilox cylinder 129 which withholds the ink that is spread thereon by means of an inking roll 128, which collects the ink from a basin 127. A doctor blade 126, coupled with the anilox cylinder 129 of the inking group 130, doses the quantity of ink.

Furthermore, a phasing group 118, of the “dancer” type, is also envisaged in this case, essentially consisting of a rod 122, carrying a pair of return rolls 123 at its ends, on which the strip of material 17 runs. The phasing group 118 can be raised or lowered, before the activation of the printing operation, so as to establish the quantity of material diverted between a printing effected in correspondence with the first contrast cylinder 113 and the cliché-holder cylinder 112 and the subsequent printing effected in correspondence with the second printing contrast cylinder 114.

Also in this case, in relation to the dimension of the cliché 115 and 116, the rates of the cylinders are regulated, whereas the strip of material 17 advances at a constant rate. With the advancing of the strip of material 17, there are initially, as previously for the punching, printed sections alternating with non-printed sections. In any case, at the outlet of the cliché-holder cylinder 112 and the second printing contrast cylinder 114, there is a completely printed strip as preestablished.

The same considerations are also valid for any other type of printing, such as offset printing, serigraphic printing, hot printing, etc., once the appropriate arrangements have been coupled with the main group of printing and contrast cylinder or the like. As already specified, the same considerations apply in the presence of a cliché-holder belt in the place of the cliché-holder cylinder 112 as rotating closed-ring element carrying the pair of clichés 115 and 116.

The functioning is therefore clear from what is described above.

It can thus be seen that a punching, embossing, engraving or printing system with a limited encumbrance according to the invention achieves the objectives specified above.

The punching, embossing, engraving or printing system with a limited encumbrance has a particularly simple structure and does not require complicated part arrangements as it can be widely adapted to the various punching and printing format sizes requested.

The punching, embossing, engraving or printing system with a limited encumbrance according to the present invention thus conceived can undergo numerous modifications and variations, all included in the same invention.

Furthermore, in practice, the materials used, as also the dimensions and components, can vary according to technical demands.

1. A punching, embossing, engraving or printing method of a continuous strip of material (17) which extends along a certain run effected by means of a punching, embossing, engraving (10) or printing (110) group in a punching, embossing, engraving or printing turret (11, 111), essentially comprising a rotating punching, embossing, engraving or printing ring element (12, 112, 212) having one or more punching, embossing, engraving or printing metal sheets or clichés (15, 115; 16, 116; 215, 216), and a pair of contrast cylinders (13, 113; 14, 114) collaborating therewith (12, 112, 212), and a phasing group (18, 118), which can be raised or lowered, wherein the continuous strip of material (17) always advances at a constant rate along the run for the punching, embossing, engraving or printing in succession of formats having a pre-established size, comprising:
a first phase for activating a reciprocal interaction cycle between said rotating punching, embossing, engraving or printing ring element (12, 112, 212) and said pair of contrast cylinders (13, 113; 14, 114), for the engagement of one or more punching, embossing, engraving or printing metal sheets or clichés (15, 115; 16, 116; 215, 216) with at least one of said pair of contrast cylinders (13, 113; 14, 114), for punching, embossing, engraving or printing a first printing format on the strip of material (17) which advances at the same linear rate as the peripheral rate of all said cylinders;
a second advance phase of said strip of material (17) between said rotating punching, embossing, engraving or printing ring element (12, 112, 212) and said pair of contrast cylinders (13, 113; 14, 114) in an area without said one or more punching, embossing, engraving or printing metal sheets or clichés (15, 115; 16, 116; 215, 216) to form an empty section or format or pass over a section or format which has already been punched, embossed, engraved or printed between the rotating ring-closed punching or printing element (12, 112, 212) and the first contrast cylinder (13, 113) of said pair of contrast cylinders (13, 113; 14, 114);
wherein in said second advance phase of said strip of material (17), said rotating punching, embossing, engraving or printing ring element (12, 112, 212) rotates at a varying rate which depends on the dimensions of said one or more punching, embossing, engraving or printing metal sheets or clichés (15, 115; 16, 116; 215, 216);
repeating said phases for the desired length of the strip of material (17) to be printed.

2. The punching, embossing, engraving or printing method according to claim 1, characterized in that it envisages a cylinder (12, 112) as rotating punching, embossing, engraving or printing ring element.

3. The punching, embossing, engraving or printing method according to claim 1, characterized in that it envisages a belt (212) as rotating punching, embossing, engraving or printing ring element.

4. The punching, embossing, engraving or printing method according to claim 1, characterized in that it envisages an initial phase in which said phasing group (18, 118) is raised or lowered before the activation of the punching, embossing, engraving or printing operation, so as to establish a quantity of material diverted between said pair of contrast cylinders (13, 113; 14, 114).

5. A punching, embossing, engraving or printing machine (10, 110) for performing a punching, embossing, engraving or printing method according to one of the claims 1 to 4, said machine (10, 110) essentially comprising a rotating punching, embossing, engraving or printing ring element (12, 112, 212), having one or more punching, embossing, engraving or printing metal sheets or clichés (15, 115; 16, 116; 215, 216), and a pair of contrast cylinders (13, 113; 14, 114) collaborating therewith (12, 112, 212), and a phasing group (18, 118), which can be raised or lowered before the activation of the punching, embossing, engraving or printing operation, so as to establish a quantity of material (17) diverted between said pair of contrast cylinders (13, 113; 14, 114).

6. The punching, embossing, engraving or printing machine (10, 110) according to claim 5, characterized in that said rotating punching, embossing, engraving or printing ring element is a cylinder (12, 112).

7. The punching, embossing, engraving or printing machine (10, 110) according to claim 5, characterized in that said rotating punching, embossing, engraving or printing ring element is a belt (212).

8. The punching, embossing, engraving or printing machine (10, 110) according to claim 5, characterized in that said phasing group (18, 118) comprises a so-called “dancer” arrangement consisting of a rod (22), carrying a pair of return rolls (23) at its ends, on which the strip of material being processed (17) runs.
